(19) United States
(12) Patent Application Publication
(10) Pub. No.: US 2021/0140219 A1
(43) Pub. Date: May 13, 2021

(54) SPINDLE DRIVE WITH INTEGRATED LOCKING DEVICE

(71) Applicant: GEBR. BODE GMBH & CO. KG, Kassel (DE)

(72) Inventor: Lars LINNENKOHL, Kassel (DE)

(21) Appl. No.: 16/617,918

(22) PCT Filed: Jun. 19, 2017
(86) PCT No.: PCT/EP2017/064961

§ 371 Date: Nov. 27, 2019

(51) Int. Cl. E05F 15/622; E05F 1/10

(52) U.S. Cl. CPC E05F 15/622; E05F 1/1058; E05Y 2201/21; E05Y 2900/148; E05Y 2900/531

(57) ABSTRACT

A spindle drive for a member to be driven, in particular a door and/or window member of a vehicle, with an integrated locking component for locking the member to be driven includes a spindle formed in the longitudinal direction and having a spindle nut disposed on the spindle. The spindle is configured to be displaceable between an opening position and a closing position. The spindle nut supports a locking device which, in the closing position, is in engagement with a stationarily arranged capturing sleeve and can be positively locked with the latter.

### TECHNICAL FIELD

The present disclosure relates to a spindle drive for a member to be driven, in particular a door and/or window member of a vehicle, with an integrated locking means for locking the member to be driven, comprising a spindle formed in the longitudinal direction and having a spindle nut, which is disposed on the spindle and which is configured to be displaceable between an opening position and a closing position, wherein the spindle nut supports a locking device which, in the closing position, is in engagement with a stationarily arranged capturing sleeve and can be positively locked with the latter.

### BACKGROUND

Spindle drives with a spindle and a spindle nut disposed on the spindle so as to be displaceable in the longitudinal direction of the spindle are known in principle. Spindle drives of this type are preferably used for opening and/or closing sliding doors. By a rotary movement of the spindle about the longitudinal direction of the spindle, the spindle nut can be displaced in the longitudinal direction, in order preferably to displace a sliding door, which is connected to the spindle nut directly or by means of a driver, between an opening position and a closing position.

In addition to the displacement of the sliding door via the spindle nut, locking devices are generally provided for locking the sliding door in the closing position. The sliding door can preferably be locked in the closing position by means of a bolt that can be pivoted into a rotary-latch lock. Such locking mechanisms may exhibit a greater need for construction space due to the rotary movement of the bolt. It is also known that the sliding door and/or the spindle can be locked by means of an engine brake of the spindle drive. The engine brake may put an additional load on the drive device.

There is a regular demand for a further development of the spindle drive for a member to be driven including a locking device, in order to reduce the need for construction space of the locking device. In addition, the costs of a spindle drive with a locking device are to be reduced.

### SUMMARY

The present disclosure provides a spindle drive by means of which a driven member, preferably a door and/or window member, can be displaced and locked in a closing position in a simple manner, wherein the construction space and component diversity of the spindle drive with the locking device can be reduced. In addition, the spindle drive is supposed to be low-cost and low-maintenance.

According to the disclosure, the advantages are achieved with a spindle drive having the features of claim 1. Advantageous and/or preferred embodiments or developments of the disclosure are each specified in the dependent claims, which may, in each case individually or in combination, represent an aspect of the disclosure.

According to the disclosure, there is provided a spindle drive for a member to be driven, in particular a door and/or window member of a vehicle, with an integrated locking means for locking the member to be driven, comprising a spindle formed in the longitudinal direction which is configured to be rotatable about its longitudinal axis, having a spindle nut which is disposed on the spindle and which is disposed so as to be displaceable in the longitudinal direction between an opening position and a closing position by means of a rotary movement of the spindle about its longitudinal axis, a locking device, which is disposed on the spindle nut and which comprises at least one ball support with an accommodating opening for a ball member, a ball member disposed in the accommodating opening, and a locking sleeve, which is disposed on the ball support and which, in the closing position, is configured to be displaceable to a limited extent, relative to the ball support, between a locking position at least partially blocking the accommodating opening and an unlocking position unblocking the accommodating opening, and a stationarily mounted capturing sleeve for locking with the locking device which, in the closing position, is in engagement in at least some portions with the locking device between the spindle and the ball support and, in the locking position, the capturing sleeve can be positively locked with the locking sleeve via the ball member.

Thus, it is an aspect of the disclosure that the spindle drive has a spindle formed in the longitudinal direction with a spindle nut which is disposed on the spindle and which can be displaced between an opening position and a closing position by means of a rotary movement of the spindle about its longitudinal axis. The spindle nut is connected, preferably directly or via a driver, to a member to be driven, particularly a door and/or window member, so that the latter can also be displaced accordingly. Preferably, the door and/or window member is a sliding member, particularly preferably a sliding door and/or a window casement. Preferably, the spindle is configured to be rotatable about its longitudinal axis by means of a drive device coupled to the spindle.

A locking device, which can be brought into engagement with a stationarily arranged capturing sleeve in the closing position of the spindle nut, is disposed on the spindle nut. Thus, the spindle nut is not only the support of the member to be driven, but at the same time also the support of the locking device.

The locking device includes at least one ball support, which is preferably disposed on a spindle nut end face oriented in the longitudinal direction of the spindle nut. As a result, the locking device can be secured on the spindle nut. The ball support has an accommodating opening for a ball member, in which a ball member is disposed. A locking sleeve is disposed on the ball support which, in the closing position of the spindle nut, is configured to be displaceable to a limited extent, relative to the ball support, between a locking position at least partially blocking the accommodating opening and an unlocking position unblocking the accommodating opening. As a result, the locking sleeve can be displaced between the unlocking position and the locking position exclusively in the closing position of the spindle nut.

In the closing position of the spindle nut, the stationarily mounted capturing sleeve for locking with the locking device is in engagement in at least some portions with the locking device, wherein the capturing sleeve is disposed at least in some portions between the spindle and the ball support. As a result, the spindle is guided, on the one hand, by the locking device, particularly the ball support, and by the stationarily arranged capturing sleeve on the other hand. In this way, a spindle drive with an integrated locking device is provided, which is formed in the longitudinal direction of the spindle, whereby the construction space of the spindle drive with the integrated locking device can be reduced.

After the spindle nut, by rotating the spindle, has been displaced into the closing position and brought into engagement with the capturing sleeve, the locking sleeve disposed on the ball support can be displaced from the unlocking position into the locking position in order to lock the capturing sleeve with the locking device, whereby it blocks the accommodating opening, displaces the ball member disposed in the accommodating opening, and positively locks the capturing sleeve with the locking sleeve via the ball member.

A preferred development of the disclosure is that the ball support is configured as a ball support sleeve, and the accommodating opening is disposed in a direction perpendicular to the longitudinal direction of the ball support sleeve and has an inner opening directed inwards in the radial direction and an outer opening directed outwards in the radial direction, and the ball member can be displaced within the accommodating opening in such a way that it is guided, at least in some portions, by the outer opening and/or, at least in some portions, by the inner opening. Thus, the inner opening is formed on a side facing towards the spindle, and the outer opening is formed on a side facing away from the spindle. A diameter of the ball member is greater than a distance between the outer opening and the inner opening. Thus, the ball member can be guided at least in some portions by the inner opening and/or the outer opening. In the locking position of the locking sleeve, the accommodating opening, and thus the outer opening, is blocked. As a result, the ball member is guided in some portions by the inner opening and can form a positive fit with the capturing sleeve disposed between the ball support and the spindle. In the unlocking position, the locking sleeve unblocks the outer opening, so that the ball member can at least partially be guided by the outer opening. Thus, the positive fit by means of the ball member between the capturing sleeve and the locking sleeve can be canceled.

An advantageous development of the disclosure provides that a diameter of the inner opening is the same as or different from a diameter of the outer opening. Thus it is provided, in principle, that the diameter of the inner opening is equal to the diameter of the outer opening. Such an accommodating opening can be easily formed by a bore hole. It is also possible, however, that the diameter of the inner opening is different from the diameter of the outer opening. Particularly preferably, it is preferred that the diameter of the outer opening is greater than the diameter of the inner opening. In this way, a stop for the ball member can be formed by the circumference of the inner opening. As a result, the reduced diameter of the inner opening may provide a securing means for the ball member on a side of the ball support facing towards the spindle.

According to a preferred development of the disclosure, it is provided that the locking sleeve has a release portion extending in the longitudinal direction and a locking portion adjacent in the longitudinal direction, wherein the release portion has a widened inner diameter relative to the locking portion, starting from an end face facing away from the spindle nut. In the unlocking position, the release portion blocks the accommodating opening and/or the outer opening at least in some portions, wherein the ball member can be guided at least in some portions by means of the outer opening due to the widened inner diameter. On the one hand, a securing means, particularly an outer securing means, for the ball member is provided by the release portion covering the accommodating opening in the unlocking position. On the other hand, the ball member can be displaced at least partially by the outer opening, whereby the positive fit between the capturing sleeve and the locking sleeve can be disengaged.

In this context, a preferred development of the disclosure is that a stop, which is preferably configured to be inclined relative to the longitudinal axis, is formed between the release portion and the locking portion on a side of the locking sleeve which, in the radial direction, faces inwards. The transition between the widened inner diameter in the release portion and the inner diameter of the locking portion thus forms the stop, wherein the stop is preferably formed in an inclined manner or has a peripheral chamfer. When the locking sleeve is displaced from the unlocking position into the locking position, the inclined stop can easily displace the ball member guided by the outer opening in the radial direction in the direction of the spindle axis, for positively connecting and/or locking the locking sleeve with the capturing sleeve.

The locking sleeve is disposed on the ball support so as to be displaceable, preferably in the longitudinal direction, between the locking position and the unlocking position. In this context, a mechanical limit may preferably provided, which may be configured in any way. An advantageous development of the disclosure is that an annular member, preferably a snap ring, which is preferably disposed in a peripheral first groove formed on the outer lateral surface, is disposed on an outer lateral surface of the ball support between the accommodating opening and a first ball support end face facing away from the spindle nut. The annular member forms a stop on the side of the ball support, which limits the displacement of the locking sleeve in the locking position, with the stop of the locking sleeve preferably resting against the annular member.

An advantageous development of the disclosure is that the ball support has a flange member on a second ball support end face facing towards the spindle nut. The flange member can limit the displacement of the locking sleeve in the unlocking position. As a result, the locking sleeve is preferably displaceable on the ball support between the annular member and the flange member. Furthermore, the flange member can serve as an attaching member for arranging and/or attaching the ball support on the spindle nut. Suitable fastening means can be guided through the flange member and connected to the spindle nut. Attaching means may preferably be screws and/or rivets, wherein the attaching means are not limited thereto.

In principle, the locking sleeve may be displaced between the locking position and the unlocking position by means of an operating member. An advantageous development of the disclosure is that the locking sleeve can be displaced from the locking position into the unlocking position against a spring force of a first spring member. As a result, the locking sleeve is automatically retained in the locking position by means of the spring force of the first spring member and must be displaced against the spring force of the first spring member in order to be displaced into the locking position.

Advantageously, it is provided that the first spring member is supported by the flange member of the ball support. In this way, a compact locking device that is capable of being biased can be provided, which can easily be attached to the spindle nut.

An advantageous development of the disclosure is that a spring base which, in the unlocking position of the locking sleeve, is arranged so as to be longitudinally displaceable between a first position at least partially blocking the accommodating opening and a second position unblocking the accommodating opening, is disposed between the ball support and the spindle. In the first position, the spring base blocks the accommodating opening and/or the inner opening, so that the ball member is not guided by the inner opening. Rather, the ball member is at least partially guided by the outer opening and is preferably retained in the accommodating opening by the release portion of the locking sleeve. In the second position, the spring base unblocks the accommodating opening and/or the inner opening, so that the ball member can be displaced at least in some portions by the inner opening. The locking sleeve can be displaced from the unlocking position into the locking position and cover or block the outer opening. As a result, the spring base may provide an inner securing means for the ball member.

In this context, a preferred development is that the spring base can be displaced from the first position into the second position against a spring force of a second spring member. As a result, the spring base is automatically retained in the first position blocking the accommodating opening and/or the inner opening by the spring force of the second spring member. Preferably, the second spring member is supported by the spindle nut end face.

A preferred development of the disclosure provides that the spring base, in the first position, retains the locking sleeve in the unlocking position in a biased manner. Preferably, the spring base is retained in the first position by the spring force of the second spring member, whereby the inner opening is blocked. As a result, the ball member disposed in the accommodating opening is guided by the outer opening. The locking sleeve is biased by the first spring member and, in the unlocking position, preferably rests against the ball member with the stop. By displacing the spring base from the first position into the second position, the inner opening is unblocked. As a result, the ball member is at least in some portions displaceable by the inner opening, so that the biased spring force of the first spring member can displace the locking sleeve from the unlocking position into the locking position.

In this way, a mechanical locking device can be provided that can be triggered quickly and reacts immediately. The latter is comparable to a snap lock.

According to a preferred development of the disclosure, it is provided that the capturing sleeve has at least one attaching portion and an engaging portion, wherein the engaging portion has, on an outer circumferential surface, a second groove formed in the circumferential direction. As a result, the engaging portion can preferably be brought into engagement with the locking device. For this purpose, the engaging portion of the capturing sleeve preferably reaches into a gap formed at the first ball support end face between the spindle and the ball support. Thus, the spring base is displaced from the first position into the second position, preferably against the spring force of the second member. The second groove is disposed in the region of the inner opening, so that the ball member at least in some portions protrudes over the inner opening and is able to reach into the second groove. By displacing the locking sleeve from the unlocking position into the locking position, whereby the outer opening is blocked, a positive fit between the capturing sleeve and the locking sleeve can be provided in a simple manner by means of the ball member.

In an advantageous development of the disclosure, it is provided that a damping member, against which the first ball support end face preferably abuts in the closing position, is disposed between the attaching portion and the engaging portion. In this way, impacts during the closing process and/or during the engagement of the capturing sleeve with the locking device can be dampened in a simple manner.

In principle, the locking sleeve may be displaced between the locking position and the unlocking position by means of an actuating member. An advantageous development of the disclosure is that the locking sleeve is connected to the spindle nut via a trigger plate configured to be displaceable on the spindle nut, and the trigger plate can be displaced via the spindle nut so that the locking sleeve can be displaced between the unlocking position and the locking position.

An advantageous development of the disclosure is that the locking position of the locking sleeve in the closing position can be detected by means of a limit switch. The limit switch may preferably be a snap-action switch. However, it may not be limited thereto but may also be configured differently. Preferably, the limit switch may provide information to the effect that, before the driving action for a rotation of the spindle about the longitudinal spindle axis can be executed for displacing the spindle nut, the positive lock between the capturing sleeve and the locking sleeve must first be disengaged.

In an advantageous development of the disclosure, it is provided that a cable for an emergency release of the locking sleeve is disposed on the locking sleeve and/or the trigger plate. In this way, the locking sleeve can be displaced from the locking position into the unlocking position in a simple manner in an emergency, whereby the positive fit between the capturing sleeve and the locking sleeve can be canceled by the ball member.

In principle, it is sufficient if a displaceably disposed ball member is disposed in an accommodating opening of the ball support for the positive fit. A preferred development of the disclosure is that the ball support has a plurality of circumferentially spaced-apart accommodating openings with corresponding ball members. In this way, a consistent positive lock between the capturing sleeve and the locking sleeve can be provided.

The disclosure further relates to the use of a spindle drive according to the disclosure with an integrated locking means for locking a door and/or window member in a vehicle, in particular in a motor vehicle and/or rail vehicle, wherein the door and/or window member is connected to the spindle nut directly and/or via a connecting member.

### BRIEF DESCRIPTION OF THE DRAWINGS

The disclosure is explained further with reference to the following Figures. These exemplary embodiments are not to be understood as limiting but rather as examples, and are supposed to enable the person skilled in the art to carry out the disclosure. The applicant reserves the right to make individual ones or several of the features disclosed in the exemplary embodiments the subject matter of patent claims, or to incorporate such features into existing patent claims. The exemplary embodiments will be explained with reference to Figures.

In the Figures:

FIG. 1: shows a view of the spindle drive with an integrated locking means in the closing position and the locked state, according to a preferred exemplary embodiment,

FIG. 2: shows a longitudinal section through the spindle drive in an opening position, according to the preferred exemplary embodiment,

FIG. 3: shows a longitudinal section through the spindle drive in the closing position and in the locked state, according to the preferred exemplary embodiment of the disclosure.

### DETAILED DESCRIPTION OF THE DRAWINGS

FIG. 1 shows a view of a spindle drive 10 for a member to be driven, in particular a door and/or window member of a vehicle, with an integrated locking means for locking the member to be driven. The spindle drive 10 has a spindle 12 formed in the longitudinal direction with a spindle nut 16 which is disposed on the spindle 12 and which can be displaced between an opening position and a closing position by means of a rotary movement of the spindle 12 about its longitudinal axis 14. The spindle nut 16 can be connected, directly or via a driver, to a member to be driven, particularly a door and/or window member, so that the member to be driven can also be displaced accordingly. Preferably, the spindle 12 is configured to be rotatable about its longitudinal axis 14 by means of a drive device (not shown) coupled to the spindle 12.

A locking device 20, which in the present case is shown spaced-apart from the spindle nut 16 for the sake of clarity, is disposed on a spindle nut end face 18 of the spindle nut 16 oriented in the longitudinal direction of the spindle 12. In the present case, the spindle nut 16 is shown in the closing position, wherein the locking device 20 is brought into engagement with a stationarily arranged capturing sleeve 22. The capturing sleeve 22 is secured on a housing attachment means 24 for arrangement on a housing. Thus, the spindle nut 16 is not only the support of the member to be driven, but at the same time also the support of the locking device 20.

The locking device 20 includes at least one ball support 26, which is preferably disposed on the spindle nut end face 18 oriented in the longitudinal direction of the spindle nut 16. As a result, the locking device 20 can be secured on the spindle nut 16 in a simple manner. The ball support 26 has an accommodating opening 28 for a ball member 30, in which a ball member 30 is disposed so as to be displaceable in a limited manner. In FIG. 1, the accommodating opening 28 and the ball member 30 are blocked by the locking sleeve 32 disposed on the ball support 26. In the closing position of the spindle nut 16, the locking sleeve 32 is configured to be displaceable to a limited extent in the longitudinal direction of the spindle, relative to the ball support 26, between a locking position at least partially blocking the accommodating opening 28 and an unlocking position unblocking the accommodating opening 28. As a result, the locking sleeve 32 can be displaced between the unlocking position and the locking position exclusively in the closing position of the spindle nut 16.

In the closing position of the spindle nut 16, the stationarily mounted capturing sleeve 22 for locking with the locking device 20 is in engagement in at least some portions with the locking device 20, wherein the capturing sleeve 22 is disposed at least in some portions between the spindle 12 and the ball support 26. As a result, the spindle 12 is guided, on the one hand, by the locking device 20, particularly the ball support 26, and by the stationarily arranged capturing sleeve 22 on the other hand. In this way, a spindle drive 10 with an integrated locking means is provided, which is formed in the longitudinal direction of the spindle 12, whereby the construction space of the spindle drive 10 with the integrated locking means can be reduced.

The spindle nut 16 is displaced into the closing position by a rotation of the spindle 12 about its longitudinal axis 14. The locking device 20 is in engagement with the capturing sleeve 22, and the locking sleeve 32 disposed on the ball support 26 is displaced into the locking position, whereby it blocks the accommodating opening 28, displaces the ball member 30 disposed in the accommodating opening 28, and positively locks the capturing sleeve 22 with the locking sleeve 32 via the ball member 30.

FIGS. 2 and 3 each show a longitudinal section through the spindle drive 10, wherein FIG. 2 shows the spindle nut 16 in an opening position, and FIG. 3 shows the spindle nut 16 in the closing position.

As is apparent from FIG. 2, the ball support 26 is formed as a ball support sleeve. The accommodating opening 28 is disposed in a direction perpendicular to the longitudinal direction 14 of the ball support sleeve and has an inner opening 34 directed inwards in the radial direction and an outer opening 36 directed outwards in the radial direction. The ball member 30 can be displaced within the accommodating opening 28 in such a way that it is guided, at least in some portions, by the outer opening 36 and/or, at least in some portions, by the inner opening 34. As a result, the inner opening 34 is formed on a side facing towards the spindle 12, and the outer opening 36 is formed on a side facing away from the spindle 12. A diameter of the ball member 30 is greater than a distance between the outer opening 36 and the inner opening 34. The diameter of the inner opening 34 is equal to the diameter of the outer opening 36. Such an accommodating opening 28 can be easily formed by a bore hole.

On an outer lateral surface 38 of the ball support 26, between the accommodating opening 28 and a first ball support end face 40 facing away from the spindle nut 16, an annular member 42 is disposed in a peripheral first groove 44 formed on the outer lateral surface 38. As a result, the annular member 42 forms a stop on the side of the ball support.

The ball support 26 has a flange member 48 on a second ball support end face 46 facing towards the spindle nut 16. The ball support 26 can preferably be connected to the spindle nut 16 in a simple manner by means of the flange member 48.

A spring base 50 which, in the unlocking position of the locking sleeve 32, is arranged so as to be longitudinally displaceable between a first position at least partially blocking the accommodating opening 28 and a second position unblocking the accommodating opening 28, is disposed between the ball support 26 and the spindle 12. In the present case, the spring base 50 is shown in the first position. In the first position, the spring base 50 blocks the accommodating opening 28 and/or the inner opening 34, so that the ball member 30 disposed in the accommodating opening 28 cannot be guided by the inner opening 34. As a result, the ball member 30 is at least partially guided by the outer opening 36. As a result, the spring base 50 provides an inner securing means for the ball member 30 in the closing position.

The spring base 50 can be displaced from the first position into the second position against a spring force of a second spring member 52. As a result, the spring base 50 is automatically retained in the first position blocking the accommodating opening 28 and/or the inner opening 34 by the spring force of the second spring member. Preferably, the second spring member 52 is supported by the spindle nut end face 18 of the spindle nut 16.

The locking sleeve 32 is disposed on the ball support 26 so as to be displaceable between the unlocking position and the locking position, with the locking sleeve 32 being shown in the unlocking position in the present case. The locking sleeve 32 has a release portion 54 extending in the longitudinal direction and a locking portion 56 adjacent in the longitudinal direction, wherein the release portion 54 has a widened inner diameter relative to the locking portion 56, starting from the first ball support end face 40. In the unlocking position, the release portion 54 unblocks the accommodating opening 28 and/or the outer opening 36 at least in some portions, wherein the ball member 30 can be guided at least in some portions by means of the outer opening 34 due to the widened inner diameter. An outer securing means for the ball member 30 can be provided by the release portion 54 covering the accommodating opening 28 in the unlocking position.

A stop 58, which is configured to be inclined relative to the longitudinal axis 14, is formed between the release portion 54 and the locking portion 56 on a side of the locking sleeve 32 which, in the radial direction, faces inwards. The transition between the widened inner diameter in the release portion 54 and the inner diameter of the locking portion 56 thus forms the stop 58.

The locking sleeve 32 can be displaced from the locking position into the unlocking position against a spring force of a first spring member 60, wherein the first spring member 60 is supported by the flange member 48.

In the opening position of the spindle nut 16, the spring base 50 is in the first position, and the locking sleeve 32 is in the unlocking position. The spring base 50 is retained in the first position by the spring force of the second spring member 52, whereby the inner opening 34 is blocked. As a result, the ball member 30 disposed in the accommodating opening 28 is guided by the outer opening 36. The locking sleeve 32 is biased by the first spring member 60 and, in the unlocking position, rests against the ball member 30 with the stop 58.

The capturing sleeve 22 has at least one attaching portion 62 for securing the capturing sleeve 22 to the housing attachment means 24 and an engaging portion 64 wherein the engaging portion 64 has, on an outer circumferential surface, a second groove 66 formed in the circumferential direction.

FIG. 3 shows the spindle drive 10 with the integrated locking means, wherein the capturing sleeve 22 is positively locked with the locking sleeve 32 via the ball member 30. As a result, the spindle nut 16 is displaced into the closing position.

For this purpose, the engaging portion 64 of the capturing sleeve 22 preferably reaches into a gap 65 formed at the first ball support end face 40 between the spindle 12 and the ball support 26 and displaces the spring base 50 from the first position into the second position against the spring force of the second spring member 52. The second groove 66 is oriented in the radial direction relative to the accommodating opening 28, so that the ball member 30 can be displaced via the inner opening 34 into the second groove 66. The biased spring force of the first spring member 60 automatically displaces the locking sleeve 32 from the unlocking position into the locking position, whereby the outer opening 36 is blocked by the locking portion 56 of the locking sleeve 32. The stop 58 abuts against the annular member 42 and limits the displacement of the locking sleeve 32 in the locking position. In this way, a mechanical locking device 20 for positively locking the capturing sleeve 22 with the locking sleeve 32 via the ball member 30 can be provided, which can be triggered quickly and reacts immediately.

A damping member 68, against which the first ball support end face 40 abuts in the closing position, is disposed between the attaching portion 62 and the engaging portion 64. In this way, impacts during the closing process can be dampened in a simple manner.

Unlocking is effected by a displacement of the locking sleeve 32 from the locking position into the unlocking position, whereby the outer opening 36 is unblocked and the positive fit is canceled. As a result, the ball member 30 is at least partially displaceable by the outer opening 36. The engaging portion 64 can be guided out of the gap 65 between the ball support 26 and the spindle 12, wherein the ball member 30 is at least in some portions guided by the outer opening 36. By means of the biasing force of the second spring member 48, the spring base 50 is displaced from the second position into the first position, whereby the inner opening 34 is blocked. By blocking the inner opening 34 by means of the spring base 50, the ball member 30 is at least partially guided by the outer opening 36 and retains the locking sleeve 32 in the biased state in the unlocking position.

1. A spindle drive for a member to be driven, in particular a door and/or window member of a vehicle, with an integrated locking means for locking the member to be driven, the spindle drive comprising:
a spindle formed in the longitudinal direction configured to be rotatable about a longitudinal axis, having a spindle nut disposed on the spindle and which is disposed so as to be displaceable in the longitudinal direction between an opening position and a closing position by means of a rotary movement of the spindle about the longitudinal axis;
a locking device disposed on the spindle nut, the locking device having at least one ball support with an accommodating opening for a ball member, the ball member being disposed in the accommodating opening, and a locking sleeve disposed on the ball support and which, in the closing position, is configured to be displaceable to a limited extent, relative to the ball support, between a locking position at least partially blocking the accommodating opening and an unlocking position unblocking the accommodating opening; and
a stationarily mounted capturing sleeve configured for locking with the locking device which, in the closing position, is in engagement in at least some portions with the locking device between the spindle and the ball support and, in the locking position, the capturing sleeve is positively locked with the locking sleeve via the ball member.

2. The spindle drive according to claim 1, wherein the ball support is configured as a ball support sleeve, and the accommodating opening is disposed in a direction perpendicular to the longitudinal direction of the ball support sleeve and has an inner opening directed inwardly in the radial direction and an outer opening directed outwardly in the radial direction, and the ball member is displaced within the accommodating opening such that the ball member is guided, at least in some portions, by the outer opening or, at least in some portions, by the inner opening.

3. The spindle drive according to claim 2, wherein a diameter of the inner opening is the same as or different from a diameter of the outer opening.

4. The spindle drive according to claim 1, wherein the locking sleeve has a release portion extending in the longitudinal direction and a locking portion adjacent in the longitudinal direction, wherein the release portion, starting from an end face of the locking sleeve facing away from the spindle nut, has a widened inner diameter relative to the locking portion.

5. The spindle drive according to claim 4, wherein a stop is configured to be inclined relative to the longitudinal axis and is formed between the release portion and the locking portion on a side of the locking sleeve which, in the radial direction, faces inwardly.

6. The spindle drive according to claim 1, wherein an annular member is disposed on an outer lateral surface of the ball support between the accommodating opening and a first ball support end face facing away from the spindle nut.

7. The spindle drive according to claim 1, wherein the ball support has a flange member on a second ball support end face facing towards the spindle nut.

8. The spindle drive according to claim 1, wherein the locking sleeve is displaced from the locking position into the unlocking position against a spring force of a first spring member.

9. The spindle drive according to claim 1, wherein a spring base which, in the unlocking position of the locking sleeve, is arranged so as to be longitudinally displaceable between a first position at least partially blocking the accommodating opening and a second position unblocking the accommodating opening, is disposed between the ball support and the spindle.

10. The spindle drive according to claim 9, wherein the spring base is displaced from the first position into the second position against a spring force of a second spring member.

11. The spindle drive according to claim 9, wherein the spring base, the first position, retains the locking sleeve in the unlocking position in a biased manner.

12. The spindle drive according to claim 1, wherein the capturing sleeve has at least one attaching portion and an engaging portion, wherein the engaging portion has, on an outer circumferential surface, a second groove formed in the circumferential direction.

13. The spindle drive according to claim 12, wherein a damping member is disposed between the attaching portion and the engaging portion.

14. The spindle drive according to claim 1, wherein the locking sleeve is connected to the spindle nut via a trigger plate configured to be displaceable on the spindle nut, and the trigger plate is displaceable via the spindle nut so that the locking sleeve is displaced between the unlocking position and the locking position.

15. The spindle drive according to claim 1, wherein the locking position of the locking sleeve in the closing position is detected by means of a limit switch.

16. The spindle drive according to claim 1, wherein a cable for an emergency release of the locking sleeve is disposed on the locking sleeve or the trigger plate.

17. The spindle drive according to claim 1, wherein the ball support has a plurality of circumferentially spaced-apart accommodating openings with a plurality of corresponding ball members.

18. A use of a spindle drive with an integrated locking means according to claim 1 for locking a door or a window member in a vehicle, wherein the door or the window member is connected to the spindle nut directly or via a connecting member.
